(19) United States
(12) Patent Application Publication
(10) Pub. No.: US 2026/0318779 A1
(43) Pub. Date: Oct. 15, 2026

(54) HEALTH ASSESSMENT APPARATUS AND A METHOD FOR A ROTATOR

(71) Applicants: HYUNDAI MOTOR COMPANY, Seoul (KR); KIA CORPORATION, Seoul (KR); GWANGJU INSTITUTE OF SCIENCE AND TECHNOLOGY, Gwangju (KR)

(72) Inventors: Kyung Woo Lee, Hwaseong-si (KR); Dae Un Sung, Hwaseong-si (KR); Young Rock Chung, Hwaseong-si (KR); Jun Gyu Lee, Hwaseong-si (KR); Jeong Min Oh, Busan (KR); Hyun Seok Oh, Gwangju (KR)

(73) Assignees: HYUNDAI MOTOR COMPANY, Seoul (KR); KIA CORPORATION, Seoul (KR); GWANGJU INSTITUTE OF SCIENCE AND TECHNOLOGY, Gwangju (KR)

(21) Appl. No.: 19/353,082

(22) Filed: Oct. 8, 2025

(30) Foreign Application Priority Data
Apr. 14, 2025 (KR) 10-2025-0047965

(51) Int. Cl. G01M 13/045; G06F 17/14

(52) U.S. Cl. CPC G01M 13/045; G06F 17/142

(57) ABSTRACT

An apparatus for diagnosing a rotator includes a driving condition processing unit configured to measure and process a driving condition applied to a rotator included in a vehicle, a vibration signal obtaining unit configured to obtain a vibration signal of a vibration of the rotator, and a control circuit configured to perform diagnosing the rotator based on the driving condition and the vibration signal. The apparatus also includes an input device configured to transmit an input signal based on a user input to control operation of the control circuit to the control circuit and a display device configured to display various operation states of the control circuit and a result of the diagnosing of the rotator performed by the control circuit. The apparatus additionally includes a storage device configured to store a control program to control operation of the control circuit and data generated by execution of the control program.

### CROSS-REFERENCE TO RELATED APPLICATIONS

This application claims the benefit of and priority to Korean Patent Application No. 10-2025-0047965, filed on Apr. 14, 2025, the entire contents of which are hereby incorporated herein by reference.

### TECHNICAL FIELD

The present disclosure relates to a health assessment apparatus and a method for a rotator. More specifically, the present disclosure relates to a health assessment apparatus and a method for a rotator, that diagnose a failure regardless of a rotational speed condition and a machine type by integrating various driving conditions of the rotator into a static condition.

### BACKGROUND

A rotator, such as a bearing, is an important element of mechanical equipment. The rotator typically requires expensive maintenance and may cause operation of mechanical equipment to be stopped for a long time in a case of a failure.

To prevent this, a prognostics and health management (PHM) system that sets an accurate health indicator (HI) reflecting a current useful state and reliably prognoses a remaining useful life (RUL) has been developed and applied.

The PHM system extracts a feature by using a sensor, and executes diagnosis for health assessment and remaining useful life prognosis.

In general, most health assessment and remaining useful life prognosis for a rotator are executed under the same consistent driving condition.

However, in actuality, the rotator operates under various driving conditions such as a rotational speed and a force.

As described above, since a conventional PHM system that assesses health of a rotator is assessed under the same driving condition, there is a problem in that health and remaining useful life of the rotator in an actual situation where various driving conditions substantially occur cannot be accurately determined.

### SUMMARY

Driveline vibration features of machines may vary based on the machine type, even if the machines are rotator-based machines having similar structures. Therefore, whenever a new rotator-based machine is developed, new failure criterion values suitable for vibration features of the machine should be suggested, and development of a health assessment apparatus for a rotator capable of determining health and remaining useful life of a rotator under various driving conditions is required.

Various aspects of the present disclosure provide a health assessment apparatus and a method for a rotator, that diagnose a failure regardless of various rotational speed conditions and machine types.

Various aspects of the present disclosure provide a health assessment apparatus and a method for a rotator, that check a current state of an electronic vehicle driveline based on traveling conditions and vibration signals of an electronic vehicle.

According to an aspect of the present disclosure, an apparatus for diagnosing a rotator is provided. The apparatus includes a driving condition processing unit configured to measure and process a driving condition applied to a rotator in a vehicle. The apparatus also includes a vibration signal obtaining unit configured to obtain a vibration signal of a vibration of the rotator. The apparatus additionally includes a control circuit configured to perform diagnosing of the rotator based on the driving condition and the vibration signal. The apparatus further includes an input device configured to provide, to the control circuit, an input signal based on a user's input to control operation of the control circuit. The apparatus also includes a display device configured to display operation states of the control circuit and a result of the diagnosing of the rotator performed by the control circuit. The apparatus further still includes a storage device configured to store i) a control program to control operation of the control circuit and ii) data generated by execution of the control program by the control circuit.

In an aspect, the driving condition may include a speed, a radial force, an axial force, or any combination thereof.

In an aspect, the driving condition processing unit may include a driving condition application unit configured to apply two or more different forces preset for cycle to the rotator and rotate the rotator at two or more different speeds, and a driving condition measurement unit configured to measure and output a force and a speed applied to the rotator when the rotator is rotating according to the driving condition applied by the driving condition application unit.

In an aspect, the control circuit may include an order tracking unit configured to change time-domain data of the vibration signal into phase-domain data and remove one or more periodic variations of the vibration signal, an amplitude adjustment unit configured to remove one or more amplitude variations of the vibration signal based on a rotational speed, an extraction unit configured to extract periodicity of the vibration signal for each frequency, and a normalizing unit configured to remove a difference in features of signals based on a rotational speed change condition and a machine type.

In an aspect, the extraction unit may include an order signal conversion unit configured to convert the vibration signal from the phase-domain data into order-domain data, a defect frequency extraction unit configured to extract periodicity of the vibration signal including a same amplitude for frequency, and a health index extraction unit configured to extract a health index reflecting periodic features based on types of defects by vehicle type and part type.

In the assessment apparatus according to the present disclosure, the storage device may include a program domain configured to store the control program, a temporary domain configured to temporarily store data generated during execution of the control program, and a data domain configured to store data used for executing the control program and data generated during execution of the control program.

In an aspect, the data domain may include a driving condition database (DB) configured to store driving condition information for cycle with respect to a variable driving condition, a data set DB configured to store predetermined vibration data for each of one or more rotators, wherein the predetermined vibration data is obtained from a test for a same type of each of the one or more rotators from a start of rotation thereof to an occurrence of a failure under a variable driving condition, and an assessment DB configured to store criterion health index assessment information with respect to all cycles for the same type of each of the one or more rotators, and store health index assessment information with respect to all cycles for the each of the one or more rotators.

According to another aspect of the present disclosure, a method for diagnosing a rotator is provided. The method includes a driving condition processing step of measuring and processing a driving condition applied to a rotator in a vehicle. The method also includes a vibration signal obtaining step of obtaining a vibration signal of a vibration of the rotator. The method additionally includes a data normalizing step of integrating different driving conditions for the rotator into a static condition and performing normalization on a machine type. The method further includes a rotator state diagnosis step of diagnosing a state of the rotator by comparing health index assessment information of the rotator with criterion health index assessment information of a same type of rotator under a variable driving condition. The method additionally includes a diagnosis result display step of displaying a result of the comparing through a display device.

In an aspect, the driving condition may include a speed of the rotator, a radial force, an axial force, or any combination thereof.

In an aspect, the driving condition processing step may include a step of varying the speed of the rotator, the radial force, or the axial force based on a cycle to apply to the rotator, and a step of measuring the driving condition, the radial force, the axial force, and the speed, which are applied to the rotator.

In an aspect, the data normalizing step may include an order tracking process of removing one or more periodic variations of the vibration signal based on a speed change, an amplitude adjustment process of reducing one or more magnitude variations based on speed for the signal from which the one or more periodic variations have been removed, a fast Fourier transform (FFT) process of extracting periodicity of the vibration signal for each frequency, and a normalizing process of removing a difference in features based on a rotational speed change condition and a difference in features based on a machine type to reduce a health index difference based on the driving condition.

In an aspect, the fast Fourier transform (FFT) process may include a process of converting vibration data of the vibration signal into an order domain signal by setting a regular sampling interval based on an angle, a process of detecting a defect feature frequency based on a period and a magnitude of a periodic vibration component included in the order domain signal, and a step of extracting amplitudes corresponding to a feature order of the rotator, obtaining a root mean square of the extracted amplitudes to output a health index.

The apparatus and method for diagnosing a rotator according to aspects of the present disclosure may diagnose a health state for a rotator even though the rotator is not under a specific rotating condition in an actually operating machine, for example, an electronic vehicle, and may reduce maintenance time and cost by accurately determining deterioration of rotator parts and taking measure thereon. As a result, it is possible to maintain the electronic vehicle in a healthy state and increase a degree of satisfaction of a user of the electronic vehicle.

### BRIEF DESCRIPTION OF THE DRAWINGS

FIG. 1 is a block diagram illustrating a configuration of a health assessment apparatus for a rotator according to an aspect of the present disclosure.

FIG. 2 is a flowchart illustrating a health assessment method for a rotator according to an aspect of the present disclosure.

FIG. 3 is a flowchart illustrating a process of executing data normalization in the health assessment method for a rotator according to an aspect of the present disclosure.

FIG. 4A is a plot illustrating an example time domain signal, according to an aspect of the present disclosure.

FIG. 4B is a plot illustrating an example phase domain signal converted from the time domain signal of FIG. 4A, according to an aspect of the present disclosure.

FIG. 4C illustrates an example time domain vibration signal, according to an aspect of the present disclosure.

FIG. 4D illustrates a phase domain vibration signal converted from the example time domain vibration signal of FIG. 4C, according to an aspect of the present disclosure.

FIG. 5A illustrates an example phase domain signal, according to an aspect of the present disclosure.

FIG. 5B illustrates an example signal after amplitude variations depending on speed are removed from the example phase domain signal of FIG. 5A, according to an aspect of the present disclosure.

FIG. 5C is an example vibration signal, according to an aspect of the present disclosure.

FIG. 5D illustrates an example vibration signal after amplitude variations depending on speed are removed from the example vibration, according to an aspect of the present disclosure.

FIG. 6A is an example illustrating that periodicity of a time domain signal is extracted depending on a frequency, according to an aspect of the present disclosure.

FIG. 6B is an example phase domain signal after an amplitude normalization, according to an aspect of the present disclosure.

FIG. 6C illustrates an order signal extracted from the amplitude-normalized vibration signal of FIG. 6B, according to an aspect of the present disclosure.

FIG. 7A is an example order domain signal, according to an aspect of the present disclosure.

FIG. 7B illustrates example results of extracting health index from the order domain signal by calculating a root mean square (RMS), according to an aspect of the present disclosure.

FIG. 8A is an example result of extracting health index from an order domain signal, according to an aspect of the present disclosure.

FIG. 8B illustrates an example result of a normalization performed such that a difference in features for each driving condition is removed, according to an aspect of the present disclosure.

FIG. 8C illustrates health index data before differences in features depending on a rotational speed change condition and differences in features depending on a machine type are removed, according to an aspect of the present disclosure.

FIG. 8D illustrates data after the differences are removed, according to an aspect of the present disclosure.

FIG. 9A illustrates example health index data for a part (component) for driving condition, according to an aspect of the present disclosure.

FIG. 9B illustrates threshold data to compare the health index data to diagnose the part according to a health index criterion, according to an aspect of the present disclosure.

FIG. 10 is a view illustrating a current state of a rotator by executing health assessment apparatus and method for a rotator, according to an aspect of the present disclosure.

### DETAILED DESCRIPTION

With regard to examples of the present disclosure described herein, specific structural and functional descriptions are merely examples to explain various aspects of the present disclosure. Examples of the present disclosure can be executed in various forms, and should not be construed as being limited to examples described in the present disclosure.

The present disclosure can be modified in various ways and can have various forms, and thus specific examples are illustrated in drawings and are described in detail below. However, this is not intended to limit the present disclosure to a specific disclosure form. Rather, the present disclosure should be construed as including all modifications, equivalents, and alternatives within the spirit and the technical scope of the present disclosure.

Terms including ordinals such as “first”, “second”, and the like may be used in the present disclosure to describe various elements, but the elements are not limited by the terms. The terms are used merely for distinguishing one element from another element. For example, a first element may be referred to as a second element, and similarly the second element may be referred to as the first element, without departing from the spirit and scope of the present disclosure.

When it is described herein that an element is “connected” or “linked” to another element, it should be understood that the element may be directly connected or linked to the other element, but also another element may exist in between. On the other hand, when it is described herein that an element is “directly connected” or “directly linked” to another element, it should be understood that no other element may not exist therebetween. Other expressions describing relations between elements, such as “between” and “right ~between”, “adjacent to” and “directly adjacent to”, and the like, should be construed in the same way. Similarly, the expression “disposed on” may mean that an element is directly disposed on a surface of a certain element or disposed above with an interval from the surface of the certain element.

The terminology used herein is merely for describing specific examples and is not intended to be limiting of the present disclosure. Singular expressions include plural expressions, unless the context clearly indicates otherwise. In the present disclosure, it should be understood that the term “include” or “have” indicates that a feature, a number, a step, an operation, a component, a part, or a combination thereof described in the specification is present, but does not exclude the possibility of existence or addition of one or more other features, numbers, steps, operations, components, parts, or combinations thereof.

Unless otherwise defined, all terms used herein, including technical or scientific terms, include the same meaning as that generally understood by those having ordinary skill in the art. It should be understood that terms, such as those defined in commonly used dictionaries, should be interpreted as having a meaning that is consistent with their meaning in the context of the relevant art and should not be interpreted in an idealized or overly formal sense unless so defined herein.

In the present disclosure, in a case where a certain example can be realized in other ways, a function or movement described in a specific block may be executed in an order different from that described in a flowchart. For example, consecutive two blocks may be substantially executed simultaneously, in actual, or the blocks may be executed reversely depending on the related function or movement.

When a component, controller, device, element, apparatus, circuit, unit or the like of the present disclosure is described as having a purpose or performing an operation, function, or the like, the component, controller, device, element, apparatus, unit or the like should be considered herein as being “configured to” meet that purpose or to perform that operation or function. Each component, controller, device, element, apparatus, circuit, unit, or the like may separately embody or be included with one or more processors and a memory, such as a non-transitory computer-readable media, as part of the apparatus. The one or more processors may be configured to implement computer-readable instructions stored in the memory to perform the described operations.

Hereinafter, a health assessment apparatus for a rotator and a health assessment method for a rotator are described in detail with reference to the accompanying drawings.

There are various causes of vibration generated by a vibration signal of a rotator. For example, causes of vibration of a vehicle may include unbalance, parallel misalignment, angular misalignment, ball bearing outer race, ball bearing inner race, ball bearing ball damage, ball bearing fundamental, structural looseness, rotating looseness, resonance, bent shaft, cavitation, cocked bearing, journal bearing (wear), journal bearing (oil whirl), rotor rub, blade fault, electrical defect, misaligned 3-jaw coupling, misaligned 4-jaw coupling, locked gearflex coupling, and/or the like.

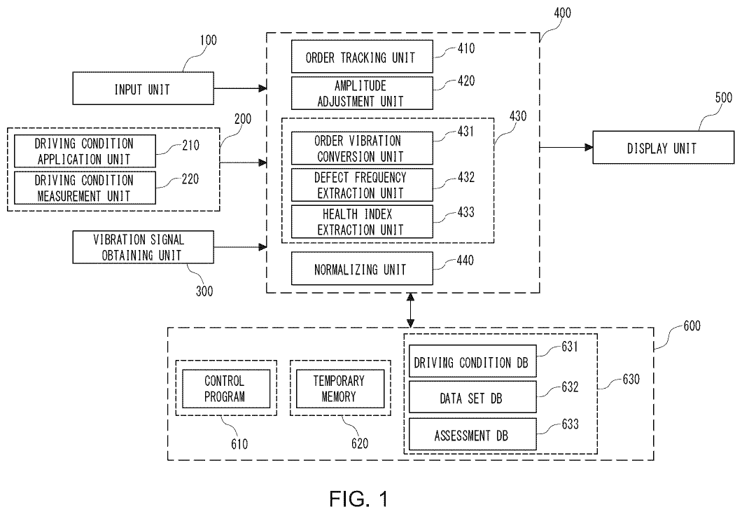

FIG. 1 is a block diagram illustrating a configuration of a health assessment apparatus for a rotator according to an aspect of the present disclosure. As illustrated, the health assessment apparatus for a rotator according to an aspect of the present disclosure includes an input device 100, a driving condition processing unit 200, a vibration signal obtaining unit 300, a control circuit 400, a display device 500, and a storage device 600.

The input device 100 provides interface means with a user by including any one or more of a modulation device including one or more of key, button, or switch. The input device 100 may also include a touch pad that outputs a position signal corresponding to a position of a screen touched integrally formed on a screen of the display device 500.

The driving condition processing unit 200 measures and processes a driving condition applied to a rotator included in an electronic vehicle driveline in real time.

The vibration signal obtaining unit 300 measures vibration generated in the rotator at a time of rotation of the rotator and obtains a vibration signal in real time. The vibration signal is time domain data of a vibration signal for three measurement directions including x axis, y axis, and z axis of the rotator and a vibration speed level for each frequency band.

The control circuit 400 assesses health of the rotator based on the driving condition measured by the driving condition measurement unit 220 and the vibration signal obtained by the vibration signal obtaining unit 300.

The display device 500 displays various operation states of the control circuit 400 and a health assessment result of the rotator in a form that can be recognized (e.g., understood) by a user.

The storage device 600 stores a control program (e.g., in the form of computer-readable instructions) for controlling operation of the control circuit 400. The storage device 600 may also store data generated by execution of the control program by the control circuit 400.

The driving condition of the rotator may include at least any one or more of a speed of the rotator, a radial force, and an axial force, which are variably applied.

The driving condition processing unit 200 includes a driving condition application unit 210 and a driving condition measurement unit 220.

The driving condition application unit 210 applies two or more different axial forces and radial forces to the rotator for each cycle, and rotates the rotator at two or more different speeds in the same cycle.

The driving condition measurement unit 220 measures a driving condition substantially applied to the rotator in a state in which the driving condition is applied to the rotator by the driving condition application unit 210 of the rotator, a radial force, an axial force, and a speed, and provides thereof to the control circuit 400.

The control circuit 400 includes an order tracking unit 410, an amplitude adjustment unit 420, an extraction unit 430, and a normalizing unit. The control circuit 400 controls overall movement of the health assessment apparatus for a rotator according to aspects of the present disclosure.

The order tracking unit 410 changes a vibration signal in time domain to a vibration signal in phase domain to remove a periodic change of the vibration signal.

The amplitude adjustment unit 420 removes an amplitude change of the vibration signal depending on a rotational speed magnitude.

The extraction unit 430 extracts periodicity of the phase domain vibration signal for each frequency.

The normalizing unit 440 removes a difference in features of signals depending on a rotational speed change condition and a machine type.

The extraction unit 430 includes an order signal conversion unit 431, a defect frequency extraction unit 432, and a health index extraction unit 433.

The order signal conversion unit 431 converts a vibration signal in a phase domain into a signal in an order domain. The order signal conversion unit 431 converts vibration and noise signals of a transmission rotator into an order signal synchronized with a rotational speed to enhance analysis accuracy.

The defect frequency extraction unit 432 extracts periodicity of the vibration signal having the same amplitude for each frequency.

The health index extraction unit 433 extracts a health index reflecting periodic features depending on the type of defects by vehicle type and part type.

The storage device 600 includes a program domain 610 storing a control program (e.g., in the form of computer-readable instructions), a temporary domain 620 temporarily storing data generated during execution of the control program, and a data domain 630 storing data necessary for executing the control program and data generated during execution of the control program.

The data domain 630 may include a driving condition database (DB) 631, a data set DB 632, and an assessment DB 633.

The driving condition DB 631 stores driving condition information for each cycle with respect to a variable driving condition.

The data set DB 632 stores vibration data obtained from a starting point of a first rotation of the same type of rotator to an occurrence point of a failure under a variable driving condition with respect to the same type of rotator as the real-time assessment target rotator as a set unit.

The assessment DB 633 stores criterion health index assessment information with respect to all cycles for the same type of rotator, and stores real-time health index assessment information with respect to all cycles for the assessment target rotator.

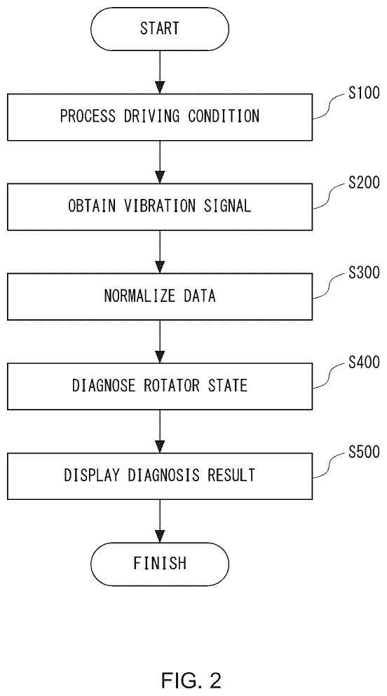

FIG. 2 is a flowchart illustrating a health assessment method for a rotator according to an aspect of the present disclosure. The health assessment method may be performed by the health assessment apparatus of FIG. 1, for example.

In a step or operation S100, the driving condition processing unit(200 measures a driving condition, a radial force, an axial force, and a speed, which are actually applied to the rotator, in a state where the driving condition is applied to the rotator, varying the driving conditions such as the axial force, the radial force, and the speed of the rotator, which are applied to the rotator included in an electronic vehicle driveline, and provides the measurements to the control circuit 400.

In a step or operation S200, the vibration signal obtaining unit 300 measures vibration generated in the rotator at a time of rotation of the rotator, obtains a vibration signal in real time, and provides the vibration signal to the control circuit 400.

In a step or operation S300, the control circuit 400 integrates different driving conditions for the rotator into a static condition and executes normalization of the machine type. In a step or operation S400, the control circuit 400 diagnoses a state of the rotator by comparing criterion health index assessment information of the same type of rotator as the rotator with real-time health index assessment information of the assessment target rotator under a variable driving condition. In a step or operation S500, the display device 500 displays a comparison result of the criterion health index assessment information and the real-time health index assessment information according to a signal provided from the control circuit 400 through a display device.

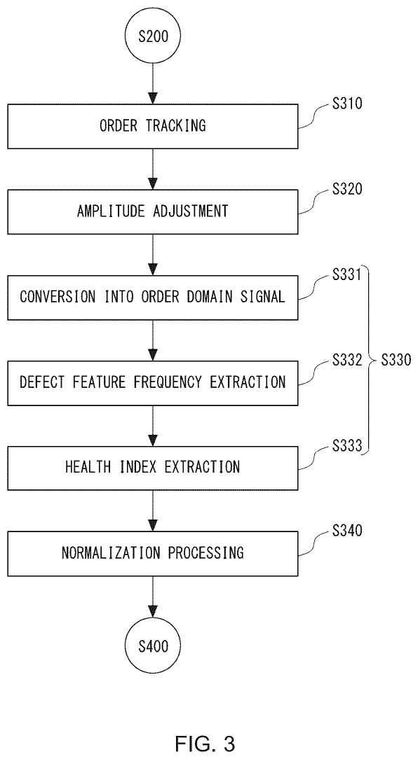

FIG. 3 is a flowchart illustrating a process of executing data normalization in the health assessment method for a rotator according to an aspect of the present disclosure. The process may be performed by the health assessment apparatus of FIG. 1, for example.

The obtained vibration signal integrates different driving conditions into a static condition through an order tracking process S310, an amplitude adjustment process S320, a fast Fourier transform (FFT) process S330, and a normalizing process S340 and executes normalization for the machine type.

In the order tracing process S310, a vibration signal for time is converted into a phase signal for an accumulated phase. The order tracking process may be referred to as order tracking. The control circuit 400 converts a vibration signal for time into a signal for an accumulated phase.

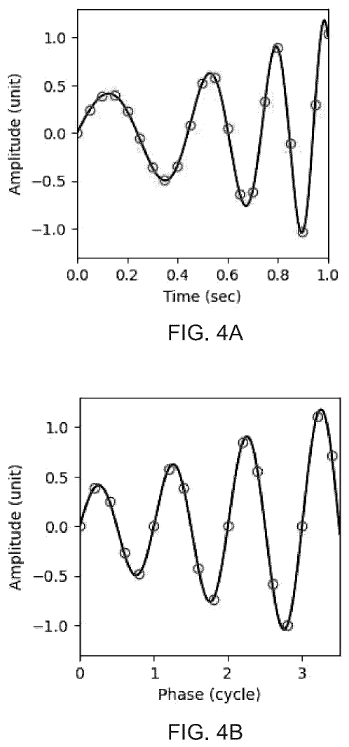

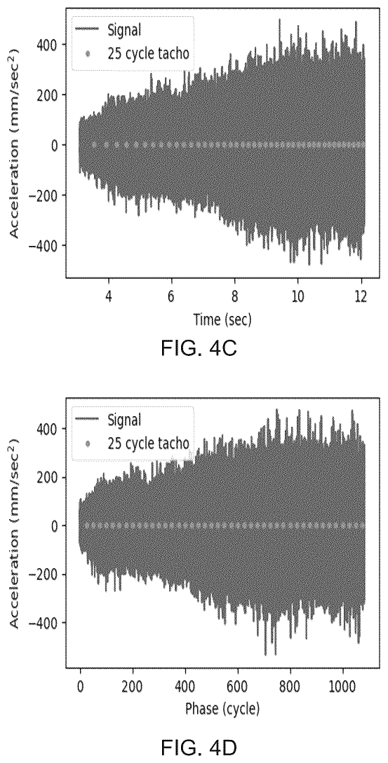

FIG. 4A is an example time domain signal and FIG. 4B is an example phase domain signal converted from the example time domain signal through the order tracing process S310. FIG. 4C is an example time domain vibration signal and FIG. D is an example phase domain vibration signal converted from the example time domain vibration signal through the order tracing process S310. As illustrated, each slope shows different detection number of times of an extracted vibration signal. As illustrated, two slopes on left side have two vibration signals, and each of two slopes on right side has a vibration signal. In addition, each slope has a different height, i.e., a magnitude of an amplitude.

A time domain vibration signal may be converted into a phase domain signal such that the same number of vibration signals are disposed on each slope of such a vibration signal.

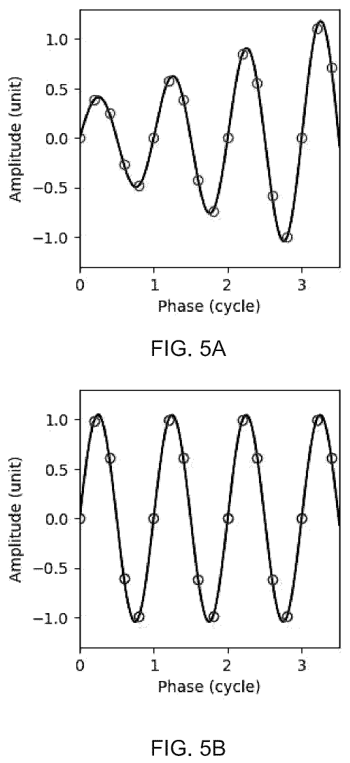

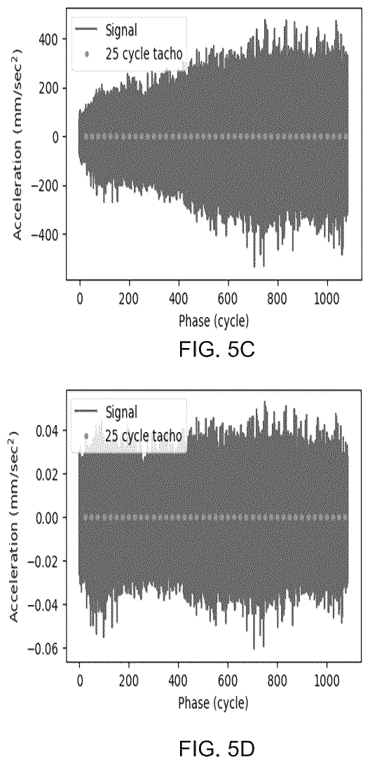

FIG. 5A is an example phase domain signal and FIG. 5B illustrates the signal for which amplitude variations depending on the speed are removed, according to an example of the present disclosure. FIG. 5C is an example phase domain vibration signal and FIG. 5D illustrates an example vibration signal after amplitude variations depending on speed are removed from the example phase domain vibration signal, according to an example of the present disclosure.

With the conversion into the phase domain vibration signal, periodicity is normalized so that the number of points for each ridge are the same from one ridge to another, but heights of ridges of the vibration signal, that is, amplitudes are different. By dividing the magnitude value of each point by the speed, amplitude variations with respect to the speed may be suppressed. Therefore, through the amplitude normalization, points are disposed in the same number for each ridge of the same amplitude.

The fast Fourier transform (FFT) process S330 includes a process S331 of converting a vibration signal into an order domain signal, a process S332 of detecting a defect feature frequency, and a health index extraction process S333. In a case where the fast Fourier transform (FFT) is used for analyzing a vibration signal, a signal that is seemingly complex in a time domain may be dismantled into multiple frequency components.

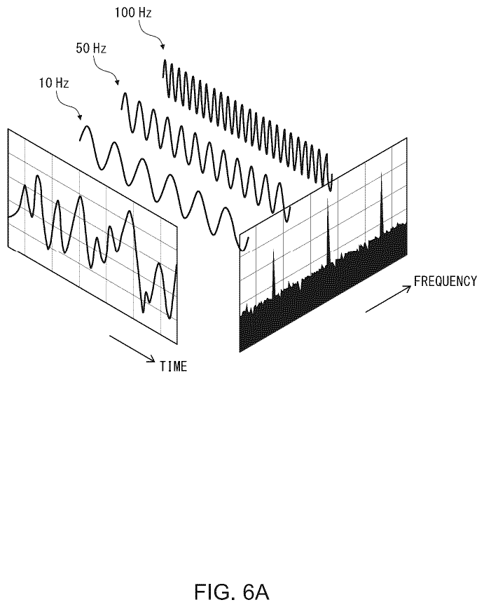

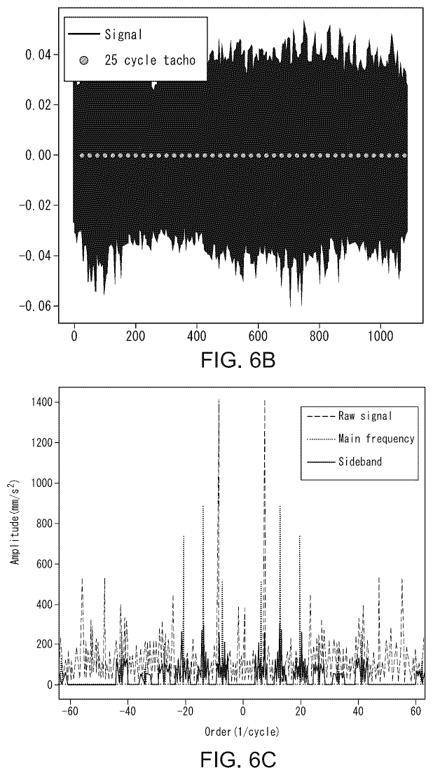

In the process S331, the FFT is applied to a vibration signal in a phase domain to obtain a signal in an order domain. FIG. 6A is an example illustrating that periodicity of a time domain signal is extracted depending on a frequency, and FIG. 6B is a graph according to an example in which the signal is converted into an order signal extracted from a vibration signal from which an amplitude change is removed, according to an example of the present disclosure.

Vibration data of a rotator is converted into an order domain signal by setting a regular sampling interval based on an angle (°), not a fixed time interval. In a case where the fast Fourier transform (FFT) is executed, a graph of amplitude vs. frequency may be obtained. For example, assuming that a signal including three frequency components such as 10 Hz, 50 Hz, and 100 Hz is analyzed, in a case where the FFT is executed on the time domain vibration signal, amplitude peaks are exhibited at 10 Hz, 50 Hz, and 100 Hz. With this, it can be recognized that the original vibration signal is formed of three periodic signals.

In a rotator, unique frequency components generated during rotation exist. A value obtained by normalizing a frequency component that changes in proportion to a rotational speed is referred to as an order. The order is a term indicating a number of times of a particular pattern or event of a vibration or noise generated when a rotating machine or element rotates one time. This is an important concept in mechanical vibration analysis, and is mainly used in diagnosis and monitoring of a rotational machine. In a case where a vehicle, which is a representative rotator, travels, there may occur vibration and noise generated in an engine, a hydraulic pump, and a gear of the vehicle. An order component is generated in the rotator, and this is important because resolution per minute (RPM) of the rotator continuously changes during traveling. For example, in a case of a vehicle, as the RPM meaning a rotational speed of an engine increases, the rotational speed of the engine becomes faster, and the pump and the gear also come to rotate fast. With this, a frequency band of the vibration and the noise generated becomes different. Therefore, order components affected by the rotational speed also increase in proportion to the rotational speed. The order means a frequency corresponding to an integer multiple of the rotational speed. For example, first order (1×) represents the same frequency as a basic rotational speed (RPM), and second order (2×) means a frequency two times the rotational speed.

In the process S332, a defect feature frequency is detected based on a periodicity and a magnitude of the periodic vibration component included in the order domain signal. A residual amplitude excluding an amplitude value corresponding to a defect feature order in a signal of the order domain obtained by applying the FFT to a vibration signal in the phase domain is changed to “0” to detect a frequency representing a defect feature.

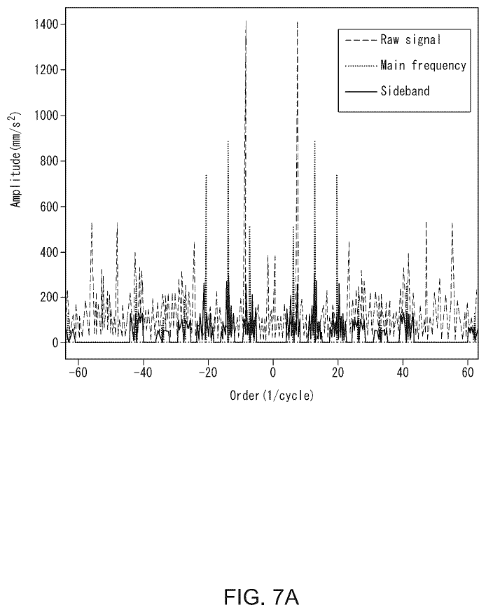

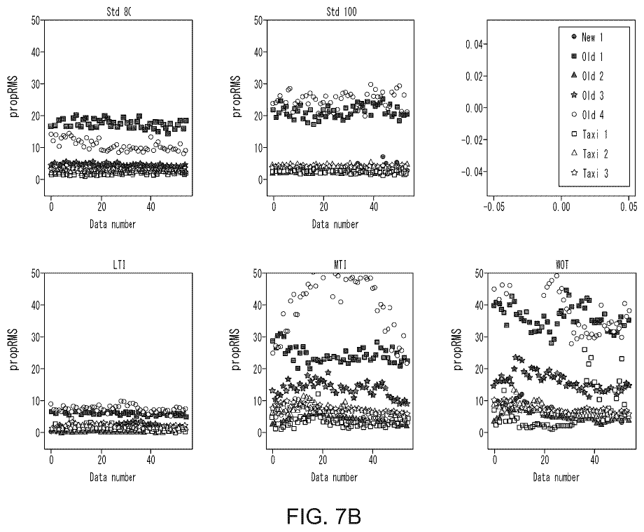

In the process S333, an amplitude corresponding to a feature order of the target rotator is extracted, and a root mean square is obtained to extract a health index. FIG. 7A is a graph of an example order domain signal and FIG. 7B illustrates example health index obtained from the order domain signal by calculating a root mean square (RMS) for each driving condition according to an example of the present disclosure. STD 80 indicates a driving condition of a constant speed of 80 kph, STD 100 a driving condition of a constant speed of 100 kph, LTI (Light tip-in) a driving condition in which a throttle valve is opened by 25%, MTI (Middle tip-in) a d riving condition in which a throttle valve is opened by 50%, and WOT (Wide open throttle) a driving condition in which a throttle valve is opened completely.

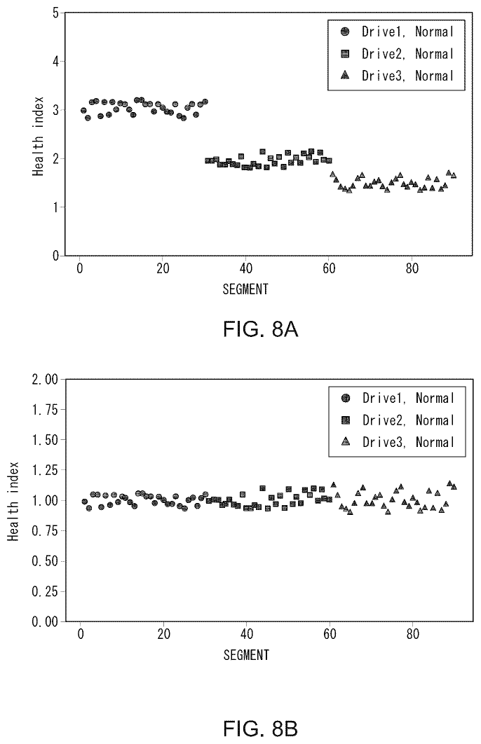

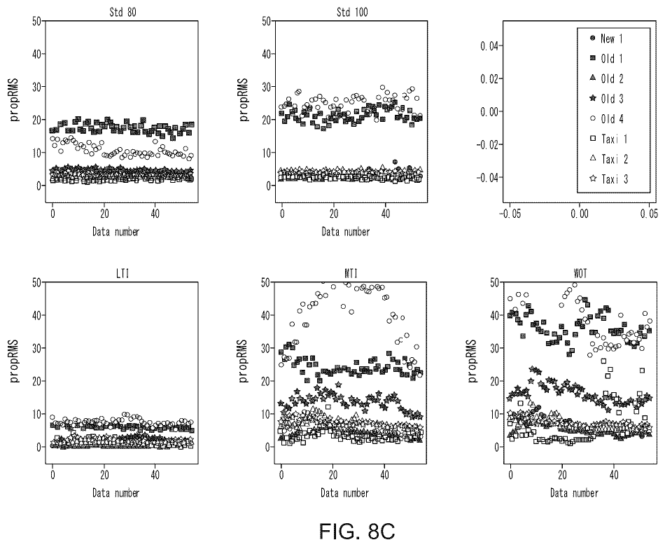

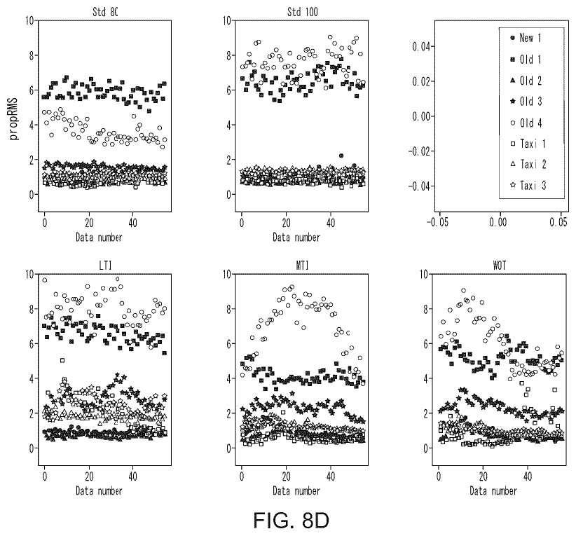

In the normalizing process S340, the control circuit 400 integrates different driving conditions into a static condition and executes normalization with respect to the machine type. FIG. 8A is example health index data and FIG. 8B illustrates the health data normalized such that differences in features for driving conditions are removed. FIG. 8C illustrates health index data before differences in features depending on a rotational speed change condition and differences in features depending on a machine type are removed, and FIG. 8D illustrates data after the differences are removed through the normalization process S340, according to an example of the present disclosure. An average and a standard deviation of a normal health index in a similar speed condition are obtained, and a health index of a vibration signal to be diagnosed is divided by an average of the normal health index to execute driving condition normalization. In health assessment apparatus and assessment method for a rotator according to the present disclosure, by converting data for failure diagnosis of a rotator into data irrelevant to driving conditions such as constant speed and acceleration/deceleration, a degree of failure or health of the rotator may be diagnosed regardless of the driving conditions, and with this, the degree of failure or health of the rotator may be diagnosed even in a case where a normal state corresponding to the same driving condition is not maintained for a long time.

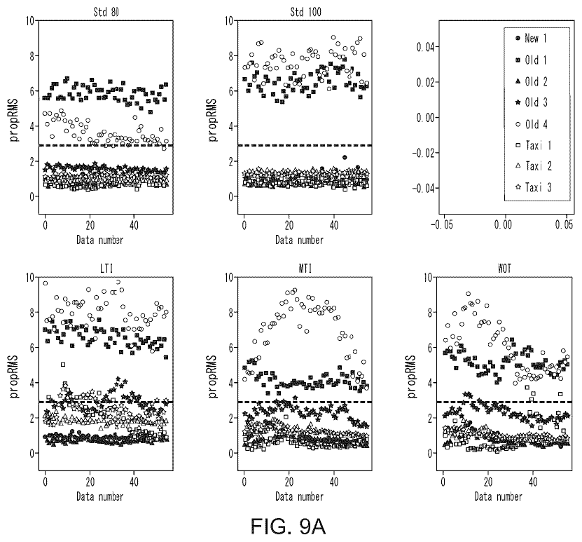

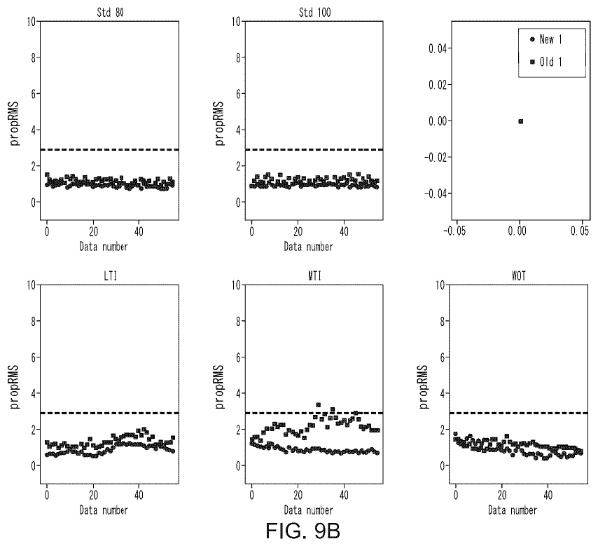

FIG. 9A illustrates example health index data for a part (component) for driving condition and FIG. 9B illustrates threshold data to compare the health index data to diagnose the part according to a health index criterion according to the present disclosure. The control circuit 400 monitors a state of a system based on statistic distribution of normal data, and diagnoses health index. The control circuit 400 assesses how much real-time measured data departs from the distribution of normal data. The control circuit 400 sets a health index threshold, and in a case where health index exceeding the threshold is detected several times, it is assumed that a defect occurs in a vehicle. In a case where health index with large difference from the threshold is detected several times, the control circuit 400 determines that the defect of the vehicle is severe. As in the present example, in a case where the threshold is set to 3 based on a graph illustrating a vibration signal in a normal state on the right side, it may be determined that as the value becomes farther from the threshold of 3, the possibility of failure gets higher. A failure state may be determined based on determining that that there occurs a vibration signal exceeding the threshold of 3 at 80 Km, 100 Km, LTI, MTI, and WOT.

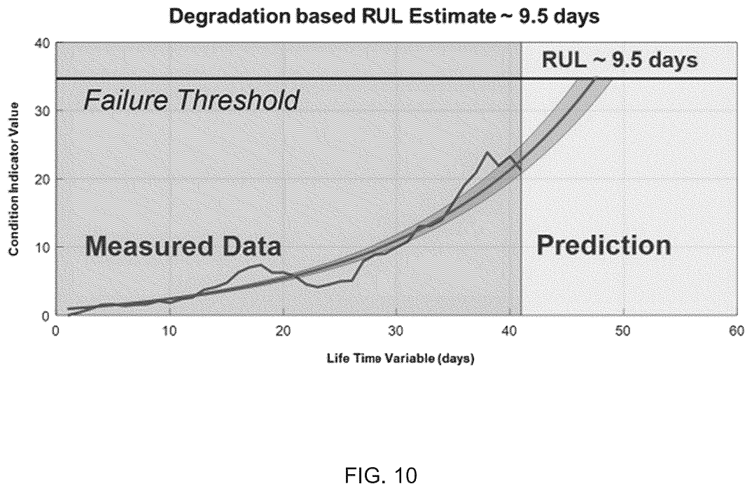

FIG. 10 is a view illustrating a current state of a rotator by executing health assessment apparatus and method for a rotator according to an aspect of the present disclosure. The control circuit 400 quantifies a current state of the system to quantitatively assess health. The control circuit 400 analyzes changes in the health index over time to assess a degree of failure progression and assumes life time variable and remaining useful life-time (RUL).

As described above, through the health assessment apparatus and assessment method for a rotator according to aspects of the present disclosure, it is possible to provide advantages such as reduction in maintenance cost, improvement of operation efficiency, and ensuring of reliability.

Hereinabove, description has been made with reference to various aspects of the present disclosure, but those having ordinary skill in the art should understand that the present disclosure can be variously modified and changed without departing from the spirit and the scope of the present disclosure as claimed in the claims below.

What is claimed is:

1. An apparatus for diagnosing a rotator, the apparatus comprising:
a driving condition processing unit configured to measure and process a driving condition applied to a rotator in a vehicle;
a vibration signal obtaining unit configured to obtain a vibration signal of a vibration of the rotator;
a control circuit configured to perform diagnosing of the rotator based on the driving condition and the vibration signal;
an input device configured to provide, to the control circuit, an input signal based on a user input to control operation of the control circuit;
a display device configured to display operation states of the control circuit and a result of the diagnosing of the rotator performed by the control circuit; and
a storage device configured to store i) a control program to control operation of the control circuit and ii) data generated by execution of the control program by the control circuit.

2. The apparatus according to claim 1, wherein the driving condition includes a speed, a radial force, an axial force, or any combination thereof.

3. The apparatus according to claim 2, wherein the driving condition processing unit includes:
a driving condition application unit configured to apply two or more different forces preset for cycle to the rotator and rotate the rotator at two or more different speeds; and
a driving condition measurement unit configured to measure and output a force and a speed applied to the rotator when the rotator is rotating according to the driving condition applied by the driving condition application unit.

4. The apparatus according to claim 1, wherein the control circuit includes:
an order tracking unit configured to change time-domain data of the vibration signal into phase-domain data and remove one or more periodic variations of the vibration signal;
an amplitude adjustment unit configured to remove one or more amplitude variations of the vibration signal based on a rotational speed;
an extraction unit configured to extract periodicity of the vibration signal for each frequency; and
a normalizing unit configured to remove a difference in features of signals based on a rotational speed change condition and a machine type.

5. The apparatus according to claim 4, wherein the extraction unit includes:
an order signal conversion unit configured to convert the vibration signal from the phase-domain data into order-domain data;
a defect frequency extraction unit configured to extract periodicity of the vibration signal including a same amplitude for frequency; and
a health index extraction unit configured to extract a health index reflecting periodic features based on types of defects by vehicle type and part type.

6. The apparatus according to claim 5, wherein the storage device includes:
a program domain configured to store the control program;
a temporary domain configured to temporarily store data generated during execution of the control program; and
a data domain configured to store data used for executing the control program and data generated during execution of the control program.

7. The apparatus according to claim 6, wherein the data domain includes:
a driving condition database (DB) configured to store driving condition information for cycle with respect to a variable driving condition;
a data set DB configured to store predetermined vibration data for each of one or more rotators, wherein the predetermined vibration data is obtained from a test for a same type of each of the one or more rotators from a start of rotation thereof to an occurrence of a failure under a variable driving condition; and
an assessment DB configured to store criterion health index assessment information with respect to all cycles for the same type of each of the one or more rotators, and store health index assessment information with respect to all cycles for the each of the one or more rotators.

8. A method for diagnosing a rotator, the method comprising:
a driving condition processing step of measuring and processing a driving condition applied to a rotator in a vehicle;
a vibration signal obtaining step of obtaining a vibration signal of a vibration of the rotator;
a data normalizing step of integrating different driving conditions for the rotator into a static condition and performing normalization on a machine type;
a rotator state diagnosis step of diagnosing a state of the rotator by comparing health index assessment information of the rotator with criterion health index assessment information of a same type of rotator under a variable driving condition; and
a diagnosis result display step of displaying a result of the comparing through a display device.

9. The method according to claim 8, wherein the driving condition includes a speed of the rotator, a radial force, an axial force, or any combination thereof.

10. The method according to claim 9 wherein the driving condition processing step includes:
a step of varying the speed of the rotator, the radial force, or the axial force based on a cycle to apply to the rotator; and
a step of measuring the driving condition, the radial force, the axial force, and the speed, which are applied to the rotator.

11. The method according to claim 8, wherein the data normalizing step includes:
an order tracking process of removing one or more periodic variations of the vibration signal based on a speed change;
an amplitude adjustment process of reducing one or more magnitude variations based on speed for the signal from which the one or more periodic variations have been removed;
a fast Fourier transform (FFT) process of extracting periodicity of the vibration signal for each frequency; and
a normalizing process of removing a difference in features based on a rotational speed change condition and a difference in features based on a machine type to reduce a health index difference based on the driving condition.

12. The method according to claim 11, wherein the fast Fourier transform (FFT) process includes:
a process of converting vibration data of the vibration signal into an order domain signal by setting a regular sampling interval based on an angle;
a process of detecting a defect feature frequency based on a period and a magnitude of a periodic vibration component included in the order domain signal; and
a step of extracting amplitudes corresponding to a feature order of the rotator, obtaining a root mean square of the extracted amplitudes to output a health index.
